(19) United States
(12) Patent Application Publication
(10) Pub. No.: US 2014/0345808 A1
(43) Pub. Date: Nov. 27, 2014

(54) FABRIC ROLLER SYSTEM AND METHOD

(71) Applicant: Harken, Incorporated, Pewaukee, WI (US)

(72) Inventors: Syd Millman, Milwaukee, WI (US); Dane Blackburn, Dousman, WI (US); Matthew Luedtke, Oak Creek, WI (US); Jeremy McMahon, Milwaukee, WI (US); John K. Harvey, JR., Atlanta, GA (US)

(73) Assignee: HARKEN, INCORPORATED, Pewaukee, WI (US)

(21) Appl. No.: 14/282,696

(22) Filed: May 20, 2014

Related U.S. Application Data
(60) Provisional application No. 61/825,900, filed on May 21, 2013.

(51) Int. Cl. E06B 9/68; E06B 9/58

(52) U.S. Cl. CPC E06B 9/68; E06B 9/58; E06B 2009/583; E06B 2009/587
USPC 160/29; 160/378; 160/311; 160/369

(57) ABSTRACT

A fabric rolling system includes a driven roller attached to a fabric. The roller is sufficiently strong and supported so as to bear increasing loads as the fabric is rolled. A fabric deployment device can also be included.

### CROSS REFERENCE TO RELATED APPLICATION

This application is based on and claims priority to U.S. Provisional Patent Application No. 61/825,900 filed on May 21, 2013, which is incorporated herein by reference in its entirety for all purposes.

### FIELD OF THE INVENTION

The present invention relates generally to the field of fabric rolling systems and devices. More particularly, the present invention relates to a device for deploying and retracting a pool cover, tarp or awning.

### BACKGROUND

Pool covers, awnings, ground covers and fabric partitions are widely used to provide various types of protection or separation. Pool covers are used to prevent evaporation and keep heat from escaping. In awning applications, large fabric flat non-porous expanses are supported by a suitable frame structure and are used to provide sun or rain protection or for decorative purposes. This may also include other soft porous fabric applications, including nets or partitions in architectural applications. The fabric used in these various applications is deployed for use and retracted when not in use, often by rolling onto a long mandrel or circular member providing an axle on which the fabric is rolled.

As the width of the fabric increases, the length of the mandrel or axle reaches a point where the weight produces significant sag on or deflection of the axle, often of many inches, so the axle and fabric are no straight. This produces such high loads on the rolling mechanisms that further rolling is no longer possible. The weight on the roll further increases as the fabric rolls onto the axle, as more material is added to the roll. To lessen this sag, the width and corresponding axle length must be limited or the dimensions and weight of the structural axle must be increased prohibitively.

Current systems can effectively only span about 25 to 40 feet. Since pools can be up to 82 feet wide and 164 feet long, or 225 feet long with multiple movable bulkheads, several separate covers are often used, and the lane lines and backstroke flags must be removed before the covers are installed. This increases the time and expense associated with using such covers.

As fabric spans increase, it becomes increasingly difficult to pull covers or awnings out evenly. They are pulled off to the side by various forces, and rolling and unrolling become difficult. Guides, such as tracks or slides on the side of the pool or awning area, are sometimes used. In other applications, rigid members are used at the deployment end of the pool cover or awning to spread out the load. Manual rolling and unrolling of such fabric must thus be done in sections, with significant difficulty and using significant manpower. The length of time required for performing this task is frequently cited as a main reason for the lack of user-acceptance. On baseball athletic fields, covers for the infield are manually deployed by about 15 people and rolled off manually using large diameter, limited length corrugated plastic pipes. Swimming pool applications can only reasonably be conducted by two people pulling the cover from either side of the deck [due to an ability to walk on water].

As such, there s a need for a system which can be operated by limited numbers of people, that can deploy and retract increased widths of fabric used as tarps, covers, awnings, and partitions, and be able to handle increased weight and size. Further, there is a need for such a system that can simplify the rolling and unrolling of larger widths and lengths of fabric, with increased speed or efficiency.

When a pool cover is unrolled and moved over the water in order to cover the pool, difficulties arise from the forward edge of the cover scooping water and diving beneath the water. This makes it difficult to move the cover over the water. A need therefore also exists to limit the scooping of water and the diving of the forward edge of the pool Cover when the cover is deployed over a pool.

### SUMMARY

Disclosed is a fabric rolling system and method, the system including an elongated support frame and a fabric roll support axle adapted to receive a length and width of fabric. The support axle has a first end rotatably mounted on the frame, and a second end connected to and rotatably mounted on the frame. In one embodiment, the system also includes a pulling system, connected between the first end of the support axle and the frame, for placing the support axle in tension. In one embodiment, the system also includes at least one fabric roll support supporting the fabric roll support axle near its midpoint, and in other embodiments, a plurality of fabric roll supports spaced apart along the support frame. In one embodiment, the fabric roll support is a cradle for supporting rotating object, the cradle having a frame and at least three spaced apart pulleys attached to the frame, all of the pulleys being in a single plane. The cradle also includes at least one continuous loop of material trained around the pulleys, with a portion of the material sagging between two of the pulleys and adapted to receive the rotating object. In one embodiment, the fabric has a forward stiff and lightweight buoyant edge across its width.

It will be understood by those skilled in the art that one or more aspects of this invention can meet certain objectives, while one or more other aspects can lead to certain other objectives. Other objects, features, benefits and advantages of the present invention will be apparent in this summary and descriptions of the disclosed embodiment, and will be readily apparent to those skilled in the art. Such objects, features, benefits and advantages will be apparent from the above as taken in conjunction with the accompanying figures and all reasonable infrences to be drawn therefrom.

### BRIEF DESCRIPTION OF THE DRAWINGS

FIG. 1A is a side, partial cross-sectional view of a fabric roll support axle and drive.

FIG. 1B is a side, partial cross-sectional enlarged view of a portion of FIG. 1A, showing the connection between two pieces of the tubular axle.

FIG. 2 is a side, partial cross-sectional view of a spool drive mechanism.

FIG. 3 is a side cross-sectional view of an upper rotating bearing system.

FIG. 4 is a side view of a tension system for a fabric roll support axle.

FIG. 5 is an end perspective view showing a fabric end and how it attaches to the tubular axle.

FIG. 6 is a side perspective view of a continuous looped cradle.

FIG. 7 is a schematic view of an alternative cradle design using rollers to support the roll in a scissors action.

FIG. 8 is a schematic view of another alternative cradle design using a cradle support that adjusts in terms of its proximity to the roll.

FIG. 9 is a schematic view of another alternative cradle design using a cradle support with several spring loaded supports to adjust the supports proximity to the

FIG. 10 is a side perspective view of a deployment line collection system used to roll out fabric.

FIG. 10A is a top schematic showing the deployment line collection system shown in FIG. 10.

FIG. 11 is a perspective view of truss sections comprising a support frame for the fabric roller system.

FIG. 12 is a side perspective view of a fabric rolling system according to the invention.

FIG. 13 is a schematic side perspective view of a portion of the fabric rolling system of FIG. 12.

FIG. 14 is an end perspective view of the tension system of FIG. 4, as mounted on a support frame wall.

FIG. 15 is a side cross sectional view of the forward edge of a pool cover.

### DETAILED DESCRIPTION

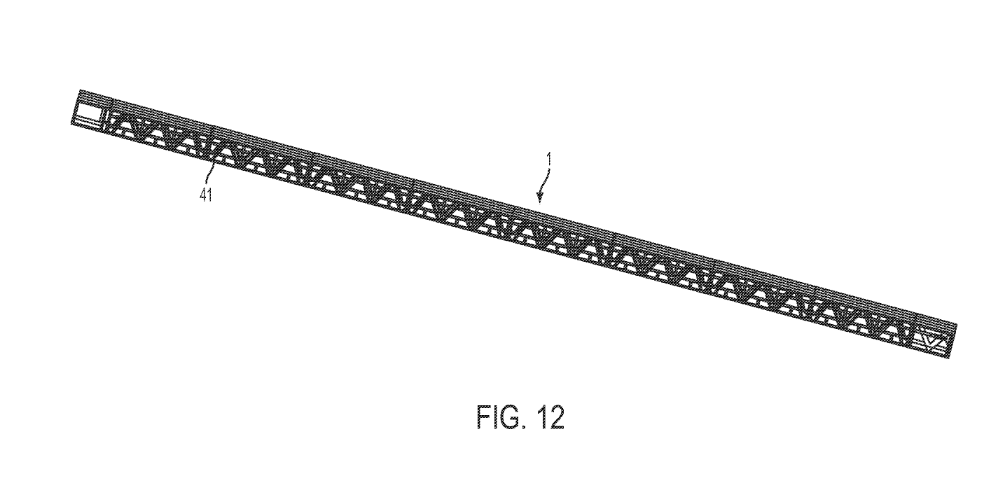

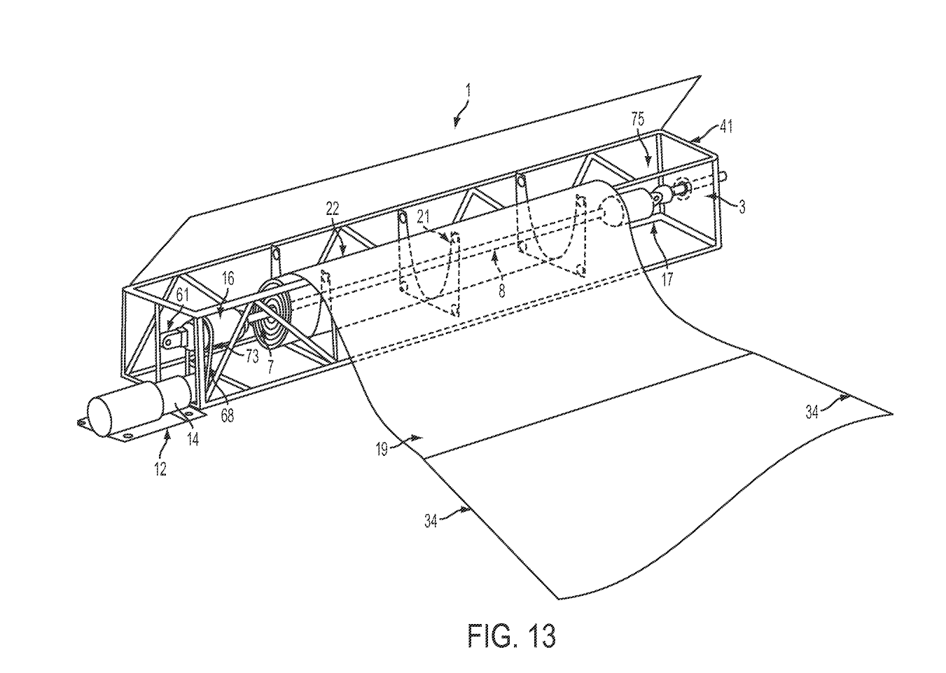

Disclosed and illustrated in the drawings is a fabric rolling system I (see FIGS. 12 and 13) adapted to receive a length and width of fabric 19, and, more particularly, large pieces of fabric such as those used for pool covers, awnings, ground covers, and fabric partitions used to provide various types of protection or space separation. In awning applications, large fabric flat expanses are supported by a suitable frame structure and are used to provide sun or rain protection or for decorative purposes.

The fabric 19 comprises porous or non-porous relatively flexible material that can roll onto itself. This may include nets or partitions in architectural applications. Suitable materials can include, but are not limited to, canvas or polyester coated with urethane, plastics such as polyethylene, polymers, coextrusions, laminations, copolymers, specialty coatings, polypropylene, polyvinyl chloride, silicone, ethylene-tetrafluoroethylene, films, woven fabrics, non-woven fabrics, including vapor barrier coatings, and other similar lightweight, flexible materials. Fabric sizes can be of any size, but when used as pool covers, fabric sizes typically range from about 82 feet wide to 164 feet long.

Pool covers are used to prevent evaporation and keep heat from escaping. The benefits of using pool covers to reduce heating, evaporation and air conditioning costs are well understood. In the case of Olympic size pools, the deployment of a pool cover can stop evaporation, and reduce energy, warmer, and chemical consumption, thereby producing cost savings amounting to hundreds of thousands of dollars per year. In the illustrated embodiment, such a pool cover is shown.

As illustrated in the drawings, the fabric rolling system I includes an elongated support frame 41 in the form of a unitary assembled modular truss structure that can have a lid or cover or bench top seat to protect the fabric and to provide seating functionality and additional functional utility when not in use. In other embodiments (not shown), the support frame can be either free standing supports, or walls of a building, or any other structure that can support an elongated mandrel. For example, the support frame 41 can be stored under a viewing stand, below a pool deck, or in a wall or on a wall, or suspended from a ceiling, where it can be raised or lowered as needed, when not in use. Further, the support frame encloses the entire rolling system, which can be utilized without the need for other reinforcement of the support frame. Thus, the system can be moved, which is especially beneficial when the system is used in tight spaces, such as in pool areas, and enables concealment of the system under a pool deck or behind a wall, or within a ceiling structure. The support frame enclosing the entire system can also be operated while raised up off the pool deck, for instance, on columns or suspended from the ceiling.

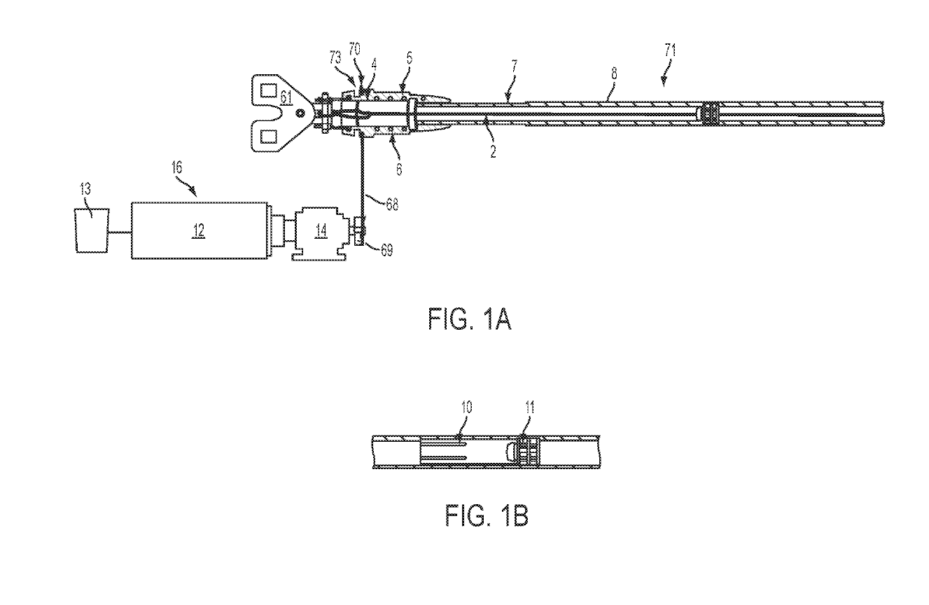

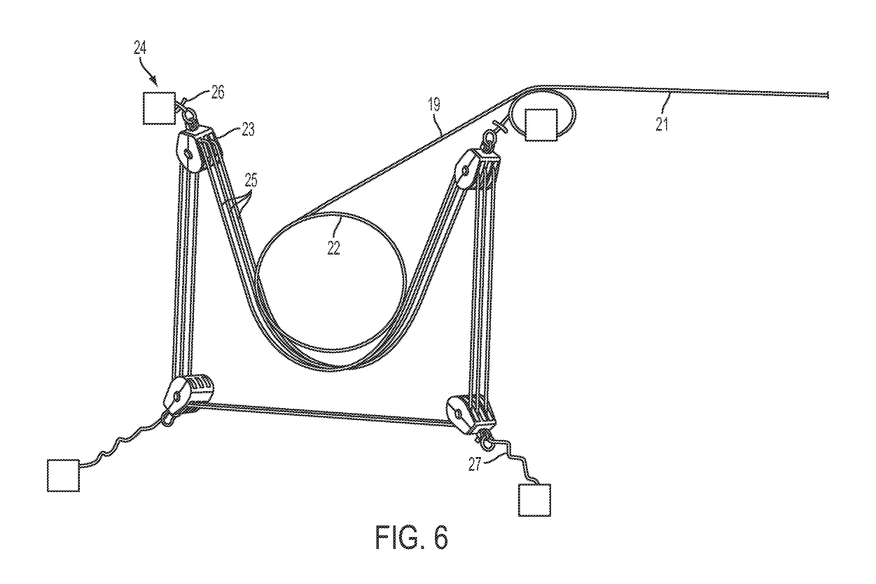

The fabric rolling system 1, as shown in FIGS. 6 to 10, and FIG. 13, also includes a fabric roll 22 including a fabric roll support axle or mandrel 71 (see FIG. 1A) that receives the fabric 19, the fabric roll support axle 71 having first end 73 (see FIG. 13) rotatably mounted on the frame 41, and a second end 75 connected to and rotatably mounted on the frame 41. In FIGS. 6, 10 and 13, the fabric 19 is shown as unrolling in a clockwise direction. In other embodiments (not shown), the fabric 19 could also be unrolled in a counterclockwise direction. The fabric rolling system I also includes, as shown in FIGS. 3, 4, 13 and 14, a pulling or tension system 3 connected between the first end 73 of the support axle and the frame 41 for placing the support axle in tension. In the illustrated embodiment, the support axle 71 includes a central support wire 2 and a tubular axle or support tube 8 rotatably mounted on the support wire, but in other embodiments (not shown), a solid rod, or a hollow tube with internal truss system, can be used. The pulling system 3 is connected to one of the wire ends, as shown in FIG. 3, and the other wire end is connected to the support frame. The tensioning system 3 is shown as being incorporated into the fabric rolling system 1, but in other embodiments (not shown), it can be supplied separate from the system 1, and used as needed for tensioning In other embodiments (not shown), a hand powered hoist with a ratchet wheel, known as a come-along, or a turnbuckle, or a similar device, can be used to place the central support wire 2 in tension.

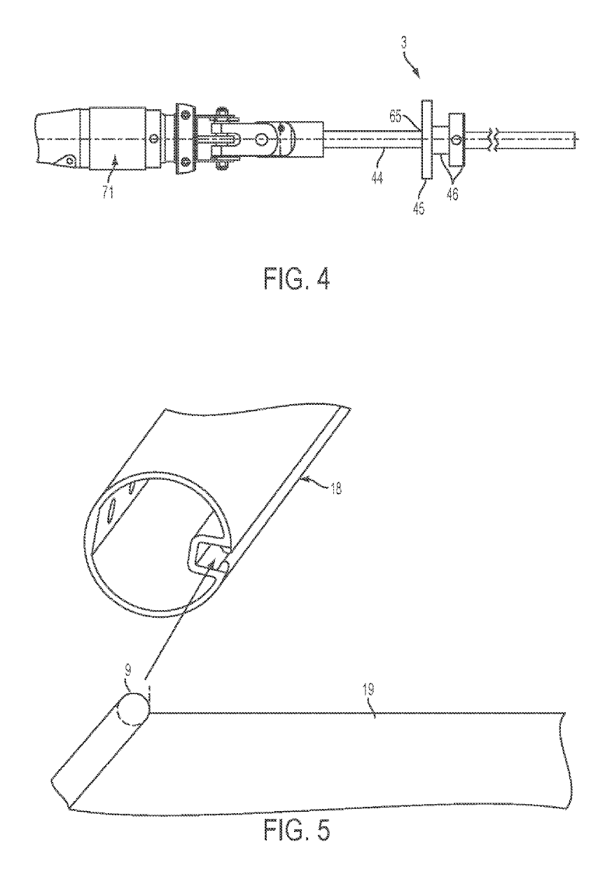

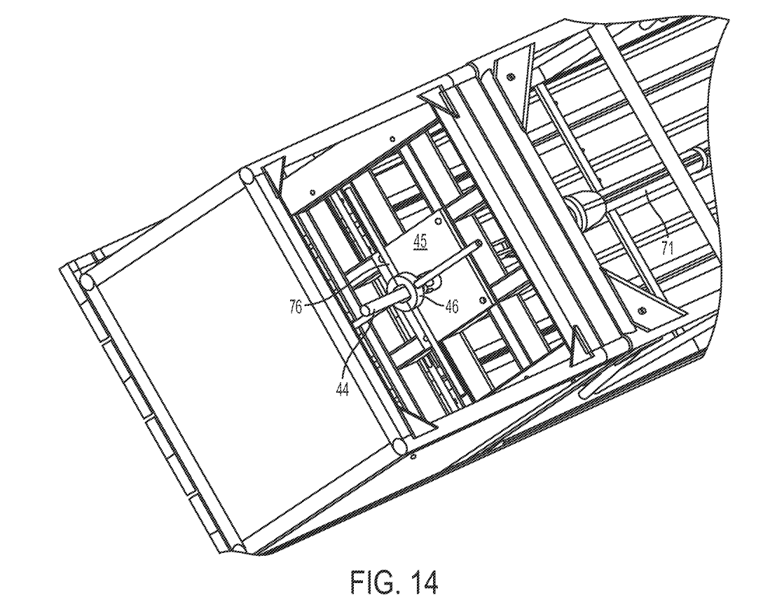

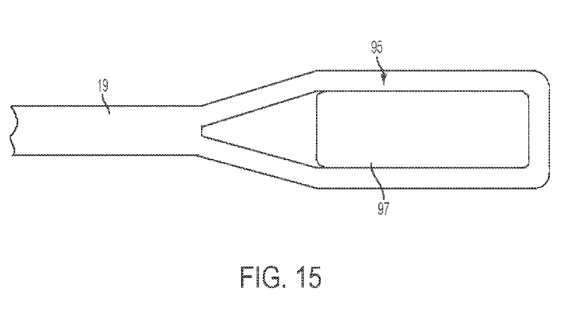

More particularly as shown in FIGS. 4 and 14, the support frame has a wall 45 with an opening 65 therein, and the fabric roll support axle 71 is rotatably mounted on one side of the wall via an extension 44 passing through the wall opening 65. The pulling system 3 comprises a threaded member 46 received on a threaded rod forming the extension, the threaded member 46 being on the other side of the wall and engaging the wall so that, as the threaded member 46 is threaded along the threaded rod 44, the threaded member 46 pulls the extension towards the wall 45, thus placing the fabric roll support axle 71 in tension. More particularly, the tension system 3 uses the threaded rod 44 that passes through the fixed wail or plate 45 attached to the end of the support frame 41 and tensions the fabric support axle using the nut 46. As shown in FIG. 14, levers 76 attached to the nut 46 allow for manual operation of the pulling system 3. In other embodiments (not shown), a powered mechanism for rotating the nut 46 can be used.

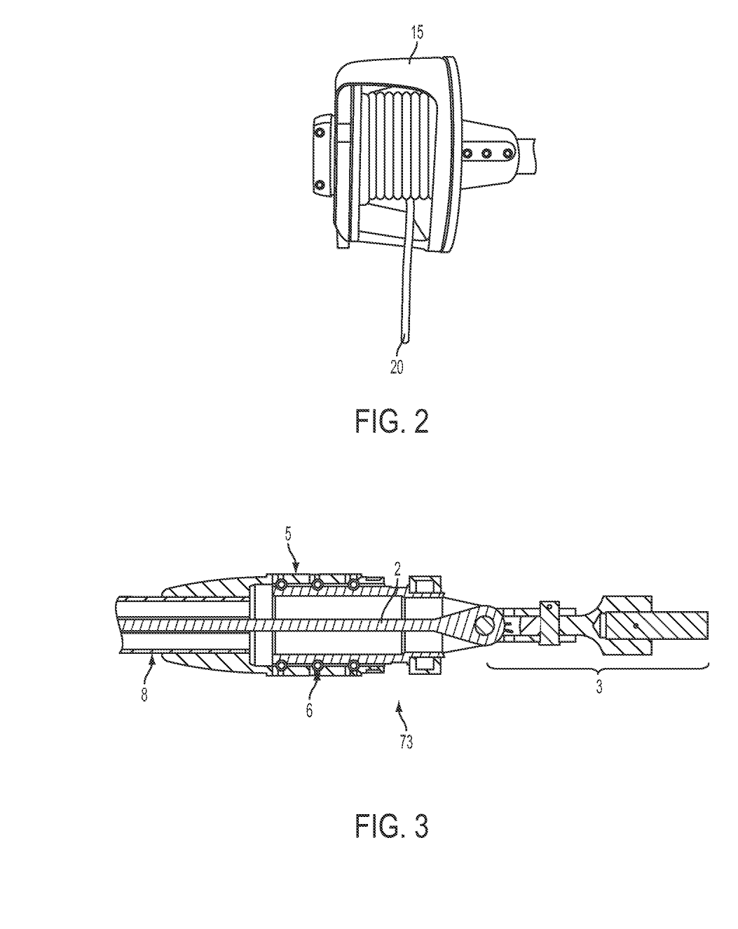

The system rolls large fabric sections by rotating the tube 8, as shown in FIG. 13, with the fabric 19 attached at its width at one end. The tube 8 fits over the high strength tensioned wire or cable 2. As shown in FIG. 3, an upper rotating bearing system 17 comprises a hub attached to the tensioning system 3, a bearing system 6, and an outer race 5 that attaches to the tube 8. More particularly, the bearing system 6 is in the form of ball bearings fitted into grooved races. Other types of bearings may be used instead of balls. The outer race is secured to an adjuster tube 7. The adjuster tube 7 allows the length of the tube 8 to vary between a drive unit 16 and the upper rotating bearing system 17. As an alternative, there may be a drive unit 116 (FIG. 2) located at each end of the tube 8, which would take the place of the upper rotating bearing system 17.

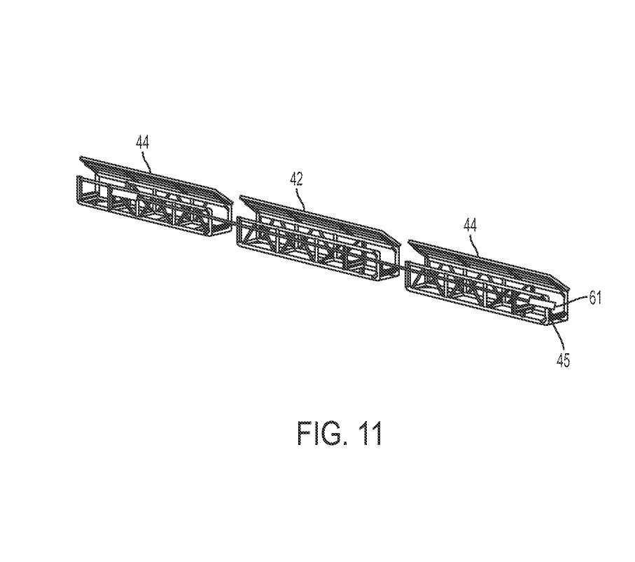

In the illustrated embodiment, the support frame 41 is a truss, as shown in FIGS. 11, 12 and 13. The truss 41 houses the fabric roll 22 of the fabric roller system 1. Anchor points 61 are located at each end of the truss 41. The roll 118 extends along inside the truss 41 and the roll 18 is stored in the truss when not in use. The high tension required for the high strength cable 2 is carried by the truss 41, as shown in FIG. 3. As such, there is no need for fastening anchor point 61 to support systems extending beyond the truss, such as to a wall. The truss 41 only needs to be secured to its supporting surface to keep it stationary to prevent movement during rolling and unrolling and to counter the rolling forces. The truss 41 can also be used as a bench area.

FIG, 11 is a perspective view of the support system for the fabric roller system including an end truss section 44 with special brackets 45 for the anchor points 61 of the system. Modular truss section 42 is in between the two end truss 41 pieces. Truss 41 is the assembled truss sections,

As shown in FIG. 1A, the high strength cable 2 runs between the anchor points 61 located on either end of the truss 41 (FIG. 11), and is a little longer than the span of the fabric 19 width, as shown in FIG. 13. The tension system 3 (FIG. 4) is used to produce enough tension to create a semi rigid line for the high strength cable 2. The tension system serves to reduce the sag in the fabric axle 71 as the fabric 19 is rolled onto the axle 71.

The anchor point 61 attaches to the high strength structure to receive the loads required to tension the system enough to provide rolling of the fabric. The high strength cable 2 provides support for the system and is tensioned to span between the two anchor points. The cable material can be 1X19 type metal cable often used in sailboat applications, fibrous cable of high strength materials such as Spectra® or Dyneemail® or Vectran®, as well as other materials. The cable may also consist of a solid metal rod or a carbon fibrous rod. The hub 4 secures to the anchor point and provides a fixed end on each side of the span.

The support tube 8 has an attachment for the fabric 19, usually in the form of grooves to receive luff tape secured to the end of the fabric. In other embodiments (not shown), the fabric may simply just be wound around the fabric roll axle. Connectors 10 join the tubular axle sections so they can be of a reasonable length for shipping and handling. They are often screwed and sometimes glued into place, but other connection methods may be employed. Bushings 11 cylindrical shaped piece to keep the high strength cable centered in the tubular axle and provide lower friction.

As seen in FIG. 5, the tube 8 has a tuff tape groove 18 running the axle's length and which secures one end of the fabric 19. The fabric has luff tape 9 commonly used for the leading edge of sails or keder rope for awning edge retention. This helps provide a straight edge for the cover and enables even positioning and rolling force geometry along the length of the axle. Other means of attaching the fabric may also be used, or the fabric may be simply wound upon the support axle. In one embodiment, the tubular axle 71 is sectioned in lengths ranging from 4’ to over 20,′ and are joined using the connectors 10. By segmenting the sections 8 of the tubular axle 71, the sections can be shipped more easily and handled more easily. A long single section tubular axle (not shown) may also be used. Bushings 11 provide low friction and keep the high strength cable 2 at the center of the tubular axle's rotation.

As illustrated in FIG. 5, a luff tape 9 is i the form of a cord that runs the width of the fabric to hold the fabric to the tubular axle. The cord has a larger diameter or dimension than the fabric so that it is held captive in the tubular axle. The tuff tape groove 18 in he tube 8 has lips to hold the luff tape 9. In order to prevent the fabric from migrating along the fabric support axle toward one or the other of the axle ends, conventional means are employed to keep the fabric in position, such a strap (not shown) connected between the respective bearing assembly 5 and its respective adjacent corner of the fabric.

In the illustrated embodiment, as shown in FIGS. 1A and 13, the fabric roll drive 16 comprises a motor 12 including an output, a motor gear box 14 including an output and an input connected to the motor output, and means connecting the motor gear box output to the support axle to rotate the axle. A chain drive 68 is driven by a sprocket 69 attached to the gearbox output to drive a sprocket 0 attached to the support tube 8.

The motor and gearbox 12 has a speed reduction gearbox to provide slower more powerful rolling. A control box 13 is stepped to reduce the motor speed to slow the rate of rolling as the diameter of the rolled fabric increases. This accommodates changes in the fabric rolling as the diameter of the roll increases and decreases as the fabric is deployed or retracted. A hand-operated drive unit with a crank could also be used. More particularly, the motor 12 is a variable speed motor, and the system includes motor control means for varying the rotational speed of the support axle with rotations as the fabric rolls onto the support axle.

The drive sprocket 69 is a toothed sprocket for chain or another type of pulley for the drive belts. The outer ace 5 rotates around the inner hub and connects to the hollow axle. The bearing system 6 reduces friction between the inner and outer hub. As the adjuster tube 7 flexes, the adjuster tube allows for variance in length of the tubular axle 71.

The motor 12 and gearbox 14 are powered by electricity or hydraulics with the gearbox usually used to reduce speed and increase power at the output end. The control box 13 has a solenoid to activate the motor and a control program.

An alternate method of rotating the tubular axle 7 can be used, such as by using line, belts or other similar long members, such as a spool drive mechanism 15. FIG. 2 is a side, partial cross-sectional view of the spool drive mechanism 15 with a line 20 attached.

As seen in FIG. 2, another drive method uses a spool drive mechanism 15 attached to the fabric support roll, which uses a line 20 which may consist of cable, rope or belts used to rotate the spool. The spool drive mechanism 14 is charged with line 20 without the fabric attached. Once the fabric is attached to the tubular axle and line is pulled, the axle rotates thereby rolling the fabric. In both drive mechanisms, when the tube 8 is rotated the fabric will roll onto the tube 8.

The fabric rolling system can also include a fabric roll suspension system with at least one fabric roll support connected to the support frame and supporting the fabric roll support axle near its midpoint, and more typically, a plurality of fabric roll supports or cradles 21 spaced apart along the support frame 41. The fabric roll supports 21 cradle the fabric roll 22, and the supports 21 accommodate a change in the size of the roll 22 as the fabric 19 is rolled and unrolled off the fabric roll axle 71. More particularly, the cradle 2.1 supports a rotating object, such as the fabric roll, and the cradle comprises the support frame 41, at least three spaced apart pulleys 23 attached to the frame, with all of the pulleys being in a single plane, and at least one continuous loop of material 25 trained around all of the pulleys. A portion of the material 25 sags between two pulleys, and is adapted to receive the rotating fabric roll. In the illustrated embodiment, the continuous loop of material is a narrow, round, stretchable polyurethane belt, but in other embodiments, other material forms, such as a tape, a sheet, rope, belt, strap, cord, line, cable, or band, whether flexible or non-flexible, can be used. If the material is wider than a belt, then other forms of a pulley, such as a roller (not shown), can be used.

Further, the fabric roll suspension system is responsive to the fabric roll diameter so that the roll supports actively accommodate changes in the diameter and weight of the fabric roll. In the embodiment illustrated in FIG. 6, this responsiveness is provided by elastic roll supports 27, formed from either elastic material or from inelastic material with spring tensioners. In other embodiments (not shown), the roll suspension system can just support the roll without being responsive to the fabric roll diameter. In the illustrated embodiment, the belts 25 move with the roll as it rotates, thus helping to reduce frictional drag on the fabric roll 22.

More particularly, as seen in FIG. 6, the cradles 21 help reduce the sag of the roll 22. The cradles 21 are placed at regular intervals along the span to reduce the sag in the tube 8 and to prevent cover material friction or abrasion from contact with the support structure or other non-moving surfaces, and to provide improved rolling at lower loads. As the fabric rolls and the diameter and weight increase, the continuous looped cradle can automatically adjust. Separation is maintained between the roll 22 and the top cradle support loops 25and any material sag points, with the bottom loops, which move in a counter-rotating direction. The combination of cable tension, rotating tube, and structure frame enables support of the pool cover across spans up to about 82 feet, supplemented by the suspension system cradle loops, which are designed to reduce or eliminate sag or deflection of the span weight and tension, and to further improve rolling and drive loads, and fabric winding control efficiency.

The cradle loops 25 travel through the pulleys 23 as the roll 22 rotates, thus providing a low friction cradled support. The cradle loops 25 can be joined in one long length to create a single loop running through multiple sheaved pulleys 23 or individually joined to create cradle loops 25 running through separate sheaves in the pulley 23. Pulleys 23 may be triples as shown or may be single, double or any other multiple sheave configurations. Such pulleys and cradle loops are reeved to provide a continuous rolling action with no end. They are loaded by assembling the loops over the pulleys 23 or by reeving them through the pulley and then joining the ends. In order for the fabric to clear the upper pulley 23, the fabric leads up over the top of the truss 24. Top connections 26 and bottom connections 27 are adjustable for desired tension and support roll positioning to achieve optimal rolling action control and minimal sag and drag characteristics within the structural support framework including cover material entry and exit angles.

The pulleys may be fixed to solid supports connected to the truss 24 or, as described above, using the elastic connection 27 so that as the weight and diameter of the roll 22 changes, the size of the cradle changes to accommodate. Furthermore, the cradle loops 25 can be elastic, so they can adjust as the roll 22 becomes larger/heavier and smaller /lighter.

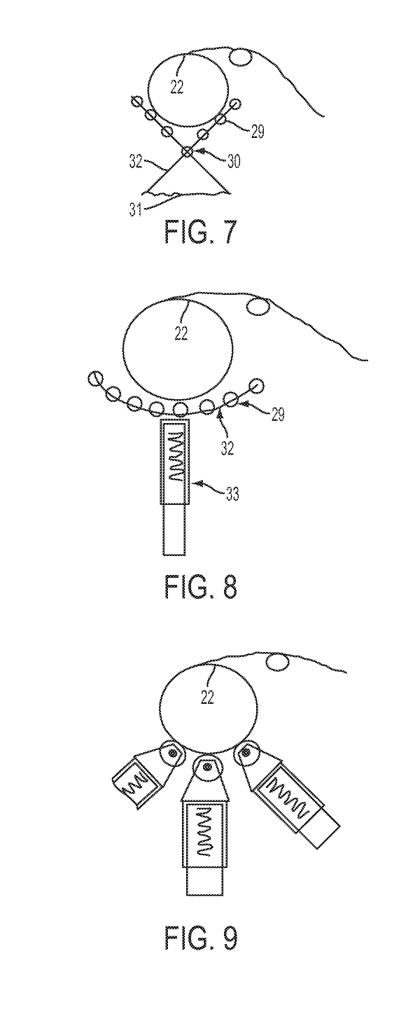

Another roll cradle system is shown in FIG. 7. A scissors action cradle system consists of rollers placed on hinged supports 30 to create a scissors type mechanism to cradle the roll 22. The elastic connection 27 can stretch to allow the size of the cradle to change as the added weight and increasing diameter of the roll 22 changes. The rollers 29 can be of any circular shape, including balls or sheaves using a variety of bearing systems or sleeves on pins. The rigid support bracket 32 is for attachments to the rollers. The hinged support 30 secures to the truss using a method to allow a scissors action. In an alternate embodiment, the elastic connection 27 or elastic cord can be a spring mechanism or piston cylinder or shocks.

As seen in FIG. 8, a roll cradle system uses rollers 29 placed on a curved or flat shape to create a cradle support. The rollers 29 can be of any quantity. The cradle support 33 may be spring loaded so that it can open as the diameter of the roll 22 increases. A spring loaded support 32 adjusts the height of the cradle as weight and diameter of the roll 22 changes.

Another variation shown in FIG. 9 is a roll support system using individual spring loaded supports with a roller 29. A spring loaded support 32 adjusts the height of the cradle as weight and diameter of the roll 22 changes. Such roller support units 33a may be used in any quantity at a given support point along the span. The support system comprises the rollers 29, a roll 22, a spring loaded support 33, and roller support unit 33a. Any or all of the pulleys may be driven by powered motor shaft to roll or help roll the system.

The fixed anchors 26 are shackles or fixed lines secured to the truss. The elastic connection 27 is connected to the fixed anchor 26 and may consist of bungee cords, springs, or any other linear piece that can stretch but provide a bias toward the fabric roll. Alternatively, a gas cylinder can be used that allows the same action as a bungee cord allowing the adjustable placement of pulleys.

The spring loaded support 33 may be a cylindrical support with a spring or a piston cylinder or a shape that collapses and springs back towards a resting state including leaf springs. The roll cradle system 47 comprises the rollers 29 mounted to the cradle support roller bar 32.

The fabric rolling system also includes a fabric pulling/outhaul system 91. In other embodiments, the fabric 19 can be unrolled by hand, so no fabric pulling system would be used.

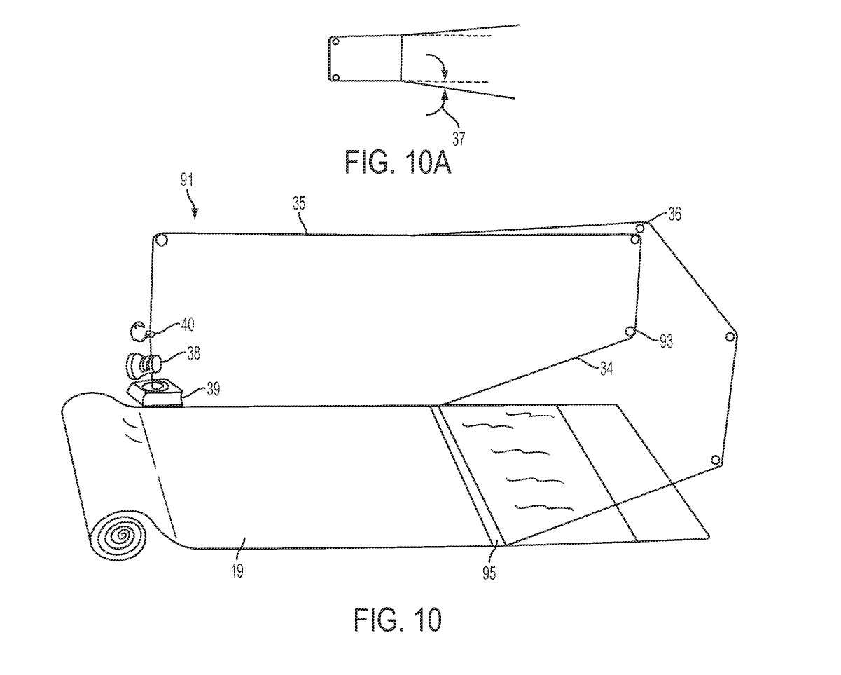

FIG. 10 is a perspective schematic and FIG. 10. A is a top schematic showing a deployment line collection or fabric pulling/outhaul system that can be used to roll out the fabric. The system 91 comprises outhaul lines 34 attached to corners of the fabric, pulleys 93, a single outhaul joiner line 35, a line collection area , out angle 37, a capstan winch 38, a line collection box 39, and a guide pulley 40.

As seen in FIGS. 10 and 10A., the deployment line collection system combines two or more outhaul lines 34 into a single line that runs to a winch which unrolls and deploys the fabric 19. Outhaul tines 34 connect to corners of fabric 19 and lead to pulleys 93 located at a slight upward angle. This height may be fixed or may change height on a track system to keep a constant upwards angle. Outhaul lines 34 continue to a tine collection area. They may go through other pulleys 36 before reaching the line collection area From there the lines may come together into the single outhaul joiner line 35. By placing pulleys 93 and 36 close together there is a straighter more efficient lead to the outhaul joiner line 35. To provide even pull to the fabric 19 the outhaul tines 34 pull at an out angle 37. This keeps the outhaul lines 34 pulling the fabric 19 at an even outward pull. Besides the two corner outhaul limes 34 several outhaul lines may be used to help support the end of the fabric. A capstan winch 38, manually, electrically or hydraulically powered, provides outhaul. Excess single outhaul joiner line 35 is kept in a line collection box 39. The single outhaul joiner tine 35 may run through a guide pulley 40 to put the line at the correct height.

In this embodiment, as shown in FIGS, 10 and 15, the forward edge 95 of the pool cover 19 is stiff, lightweight, and buoyant. More particularly, the forward edge 95 includes an air bladder 97 attached or held in a pocket formed by folding the edge of the fabric back on itself, and by sealing, stitching or gluing the fabric to itself. The air bladder 97 is air tight, but can include a valve (not shown) for adding additional air similar means of extracting air, as necessary. In addition, the bladder 97 is relatively stiff when inflated, thereby providing stiffness to the forward edge of the cover, which aids in the deployment of the cover over a pool and over common control obstructions like lane tines, bulkheads, and starting blocks without encountering snagging complications or the need to remove such obstacles to achieve efficient deployment or retraction. In other embodiments (not shown), another buoyant material could be incorporated into the pocket, or the bladder can be attached to the fabric by other means, such as by sec the bladder to the fabric, such as by gluing or heat sealing. The buoyant forward edge of the pool cover limits or prevents the scooping of water and the diving of the forward edge beneath the water, thus improving the ability of the pool cover to be readily placed over a pool. In other embodiments (not shown), the sides of the fabric can also include a buoyant piece in order to add support to the pool cover along the edges of the pool.

The lightweight fabric and large format enable covering any size pool with one single cover instead of traditional multiple smaller sections. This vapor barrier cover eliminates the need for traditional closed cell foam or air bubbles for flotation support by removing weight and bulk, thereby enabling the cover to lay on the surface of the water without sinking. This large lightweight material cover creates water surface tension characteristics to support the lay flat membrane and cohesive conditions, which aids prevention of aerodynamic lift by outdoor pool winds which sometimes blow traditional blankets off pools. Under such wind conditions, the forward edge or side edge air bladder buoyancy may not be desirable, therefore, an air valve also provides fast and easy air removal, both for purposes of roll winding during retraction, or added prevention of aerodynamic lift conditions while deployed on the pool during weather extremes.

Although the invention has been herein described in what is perceived to be the most practical and preferred embodiments, it is to be understood that the invention is not intended to be limited to the specific embodiments set forth above. Rather, it is recognized that modifications may be made by one of skill in the art of the invention without departing from the spirit or intent of the invention and, therefore, the invention is to be taken as including all reasonable equivalents to the subject matter of the appended claims and the description of the invention herein.

What is claimed is:

1. A fabric rolling system, the system comprising:
a support frame;
a fabric roll support axle adapted to receive a length and width of fabric, the axle having a first end connected to and rotatably mounted on the frame, and a second end connected to and rotatably mounted on the frame; and
a pulling system connected between the support axle and the frame for placing the support axle in tension.

2. A fabric rolling system according to claim 1, wherein the support frame is an elongated assembled structure.

3. A fabric rolling system according to claim 1, wherein the pulling system is connected between the first end of the support axle and the frame.

4. A fabric rolling system according to claim 1 wherein the support axle includes a central support wire and a support tube rotatably mounted on the support wire, the pulling system being connected to one of the wire ends, the other wire end being connected to the support frame.

5. A fabric rolling system according to claim 1 wherein the support frame has a wall with an opening therein, wherein the fabric roll support axle is rotatably mounted on one side of the wall via an extension passing through the wall opening; and wherein the pulling system comprises a threaded member received on a threaded rod attached to the extension, the threaded member being on the other side of the wall and engaging the wall so that, as the threaded member is threaded along the threaded rod, the threaded member pulls the extension towards the wall, thus placing the fabric roll support axle in tension.

6. A fabric rolling system according to claim 1 and further including a fabric roll drive connected to the fabric support axle for rotating the fabric roll axle.

7. A fabric rolling system according to claim 1 and further including a fabric roll suspension system, the system comprising at least one fabric roll support supporting the fabric roll support axle between the first end and the second end of the axle.

8. A fabric rolling system, the system comprising:
an elongated support frame;
a fabric roll support axle adapted to receive a length and width of fabric, the axle having a first end connected to and rotatably mounted on the frame, and a second end connected to and rotatably mounted on the frame; and
a fabric roll suspension system, the system comprising at least one fabric roll support supporting the fabric roll support axle between the first end and the second end of the axle.

9. A fabric rolling system according to claim 8 wherein the fabric roll suspension system further includes means responsive to the fabric roll diameter so that the roll supports actively accommodate changes in the diameter, weight, and rolling efficiency of the fabric roll.

10. A fabric rolling system according to claim 8 and further including a fabric roll drive connected to the fabric support axle for rotating the fabric roll support axle.

11. A fabric rolling system according to claim 8 wherein the fabric roll suspension system comprises a plurality of fabric roll supports spaced apart along the support frame.

12. A fabric rolling system, the system including
an elongated support frame;
a fabric roll support axle adapted to receive a length and width of fabric having a first end rotatably mounted on the frame, and a second end connected to and rotatably mounted on the frame;
a pulling system connected between the first end of the support axle and the frame for placing the support axle in tension;
the support axle including a central support wire and a support tube rotatably mounted on the support wire, the pulling system being connected to one of the wire ends, the other wire end being connected to the support frame;
a fabric roll drive for rotating the fabric roll support axle, the drive comprising a motor including an output, a motor gear box including an output and an input connected to the motor output, and means connecting the motor gear box output to the support axle to rotate the axle; and
a fabric roll suspension system, the system comprising a plurality of fabric roll supports spaced apart along the support frame.

13. A fabric rolling system according to claim 12 wherein the fabric roll suspension system further includes means responsive to the fabric roll diameter so that the roll supports actively accommodate changes in the diameter of the fabric roll.

14. A fabric rolling system according to claim 12 wherein the motor is a variable speed motor, and wherein the system includes motor control means for varying the rotational speed of the support axle with rotations as the fabric rolls onto the support axle.

15. A fabric rolling system according to claim 12 and further including a fabric pulling system.

16. A fabric rolling system according to claim 12 wherein the fabric width is greater than 24 feet.

17. A fabric rolling system according to claim 12 wherein the fabric length is greater than 60 feet.

18. A cradle for supporting a rotating object, the cradle comprising
a frame;
at least three spaced apart pulleys attached to the frame, all of the pulleys being in a single plane; and
at least one continuous loop of material trained around the pulleys, with a portion of the material sagging between two of the pulleys and adapted to receive the rotating object.

19. A cradle according to claim 18 wherein the pulleys are attached to the frame by elastic supports.

20. A fabric rolling system, the system comprising:
an elongated support frame;
a fabric having a length and width, the fabric having a forward stiff and buoyant edge across its width, and
a fabric roll support axle supporting the width of fabric, the length of fabric being able to be rolled and unrolled onto the support axle, the support axle having a first end rotatably mounted on the frame, and a second end connected to and rotatably mounted on the frame; so that the fabric can be unrolled from the support axle.

21. A method of rolling and unrolling fabric, the method comprising the steps of:
rotatably mounting on a support frame a fabric roll support axle adapted to receive a length and width of fabric, the fabric roil support axle having a first end connected to the frame, and a second end connected to the frame; and
placing the fabric roll support axle in tension in the support frame.
